(19) United States
(12) Patent Application Publication
(10) Pub. No.: US 2020/0176755 A1
(43) Pub. Date: Jun. 4, 2020

(54) METHODS FOR PRE-LITHIATING SILICON AND SILICON OXIDE ELECTRODES

(71) Applicant: GM GLOBAL TECHNOLOGY OPERATIONS LLC, Detroit, MI (US)

(72) Inventors: Xiaosong Huang, Novi (US); Xingcheng Xiao, Troy (US); Li Yang, Troy (US); Hamid G. Kia, Bloomfield Hills (US)

(21) Appl. No.: 16/209,027

(22) Filed: Dec. 4, 2018

(51) Int. Cl. H01M 4/1395; H01M 4/131; H01M 4/134; H01M 4/1391; H01M 10/0525; H01M 10/058; H01M 2/14

(52) U.S. Cl. CPC H01M 4/1395; H01M 4/131; H01M 4/134; H01M 2004/027; H01M 10/0525; H01M 10/058; H01M 2/145; H01M 4/1391

(57) ABSTRACT

Methods for pre-lithiating an anode include providing the anode having a host material comprising silicon particles or SiOₓ particles, disposing a first side of an electrically conductive pre-lithiating separator contiguous with the anode, and disposing a lithium source contiguous with a second side of the pre-lithiating separator such that lithium ions migrate to the host material via the pre-lithiating separator. The pre-lithiating separator comprises a porous body, one or more solvents, and one or more lithium ions. Method for manufacturing a battery cell, further include separating the pre-lithiating separator from the lithiated anode, and combining the lithiated anode with a battery separator and a lithium cathode to form a battery cell. The methods can further include applying a voltage to the anode and the lithium source, or maintaining a constant current between the lithium source and the anode while lithium ions migrate to the host material.

### INTRODUCTION

Lithium ion batteries describe a class of rechargeable batteries in which lithium ions move between a negative electrode (i.e., anode) and a positive electrode (i.e., cathode). Liquid, solid, and polymer electrolytes can facilitate the movement of lithium ions between the anode and cathode. Lithium-ion batteries are growing in popularity for defense, automotive, and aerospace applications due to their high energy density and ability to undergo successive charge and discharge cycles.

### SUMMARY

Provided are methods for pre-lithiating an anode. The methods include providing the anode having a host material comprising silicon particles or SiOₓ particles, wherein x is less than or equal to 2, disposing a first side of an electrically conductive pre-lithiating separator contiguous with the anode, wherein the pre-lithiating separator comprises a porous body, one or more solvents, and one or more lithium ions, and disposing a lithium source contiguous with a second side of the pre-lithiating separator for a period of time such that lithium ions migrate to the host material via the pre-lithiating separator. The methods can further include applying a voltage to the anode and the lithium source such that the magnitude of the potential between the anode and the lithium source increases. The methods can further include maintaining a constant current between the lithium source and the anode while lithium ions migrate to the host material. The lithium source can be elemental lithium or a lithium alloy. The host material can have an average particle diameter of about 20 nanometers to about 20 micrometers. The host material can include SiOₓ particles, and the host material can further include Si and/or Si₂ domains within the SiOₓ particles. The pre-lithiating separator can have an electric resistance of about 10 ohms to about 2,000 ohms. The pre-lithiating separator can have a porosity of about 20% to about 80%. The pre-lithiating separator body can include a polymeric material. The pre-lithiating separator body can include an electrically conductive filler. The electrically conductive filler can include one or more electrically conductive carbon materials, nickel fibers and/or particles and steel fibers and/or particles, and combinations thereof

Methods for manufacturing battery cells are also provide. The methods can include providing an anode having a host material comprising silicon particles or SiOₓ particles, wherein x is less than or equal to 2, disposing a first side of an electrically conductive pre-lithiating separator contiguous with the anode, wherein the pre-lithiating separator comprises a porous body, one or more solvents, and one or more lithium ions, disposing a lithium source contiguous with a second side of the pre-lithiating separator for a period of time such that lithium ions migrate to the host material via the pre-lithiating separator to form a lithiated anode, separating the pre-lithiating separator from the lithiated anode, and combining the lithiated anode with a battery separator and a lithium cathode to form the battery cell. Disposing the first side of the electrically conductive pre-lithiating separator contiguous with the anode can occur during a roll-to-roll battery cell fabrication process. The methods can further include applying a voltage to the anode and the lithium source such that the magnitude of the potential between the anode and the lithium source increases. The methods can further include maintaining a constant current between the lithium source and the anode while lithium ions migrate to the host material. The lithium source can be elemental lithium or a lithium alloy. The host material can have an average particle diameter of about 20 nanometers to about 20 micrometers. The host material comprises SiOₓ particles, and the host material further can include Si and/or Si₂ domains within the SiOₓ particles. The pre-lithiating separator body can include a polymeric material. The pre-lithiating separator body can include an electrically conductive filler.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a lithium battery cell, according to one or more embodiments;

FIG. 2 illustrates a schematic diagram of a hybrid-electric vehicle, according to one or more embodiments;

FIG. 3 illustrates a pre-lithiating system including an anode, a pre-lithiating separator, and a lithium source, according to one or more embodiments;

FIG. 4 illustrates a block diagram of a method 400 for pre-lithiating an anode and a method for manufacturing a battery cell, according to one or more embodiments;

FIG. 5A illustrates a graph of the initial coulombic efficiency of pre-lithiated and non-lithiated anodes, according to one or more embodiments; and

FIG. 5B illustrates a graph of the discharge capacity of a pre-lithiated anode and a non-lithiated anode over charge/discharge cycles, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are methods for pre-lithiating electrodes, particularly pre-lithitating lithium battery anodes, and methods for manufacturing battery cells. The methods provided herein minimize or eliminate low initial coulombic efficiency, inferior long-term cycling performance, and low energy density of battery cells.

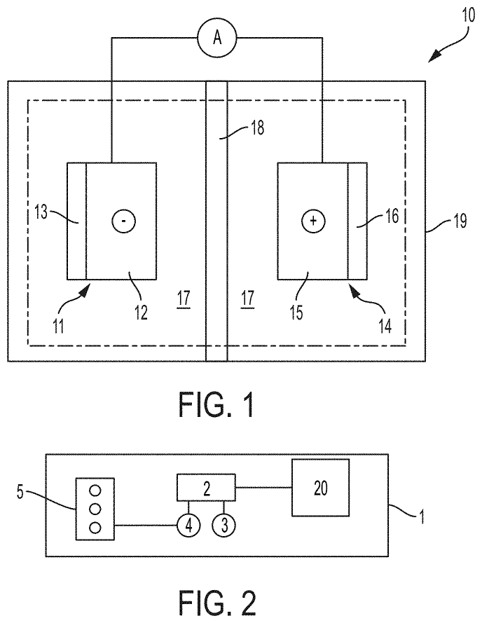

FIG. 1 illustrates a lithium battery cell 10 comprising a negative electrode (i.e., the anode) 11, a positive electrode (i.e., the cathode) 14, an electrolyte 17 operatively disposed between the Anode 11 and the cathode 14, and a separator 18. Anode 11, cathode 14, and electrolyte 17 can be encapsulated in container 19, which can be a hard (e.g., metallic) case or soft (e.g., polymer) pouch, for example. The Anode 11 and cathode 14 are situated on opposite sides of separator 18 which can comprise a microporous polymer or other suitable material capable of conducting lithium ions and optionally electrolyte (i.e., liquid electrolyte). Electrolyte 17 is a liquid electrolyte comprising one or more lithium salts dissolved in a non-aqueous solvent. Anode 11 generally includes a current collector 12 and a lithium intercalation host material 13 applied thereto. Cathode 14 generally includes a current collector 15 and a lithium-based or chalcogen-based active material 16 applied thereto. For example, the battery cell 10 can comprise a chalcogen active material 16 or a lithium metal oxide active material 16, among many others, as will be described below. Active material 16 can store lithium ions at a higher electric potential than intercalation host material 13, for example. The current collectors 12 and 15 associated with the two electrodes are connected by an interruptible external circuit that allows an electric current to pass between the electrodes to electrically balance the related migration of lithium ions. Although FIG. 1 illustrates host material 13 and active material 16 schematically for the sake of clarity, host material 13 and active material 16 can comprise an exclusive interface between the anode 11 and cathode 14, respectively, and electrolyte 17.

Battery cell 10 can be used in any number of applications. For example, FIG. 2 illustrates a schematic diagram of a hybrid-electric vehicle 1 including a battery pack 20 and related components. A battery pack such as the battery pack 20 can include a plurality of battery cells 10. A plurality of battery cells 10 can be connected in parallel to form a group, and a plurality of groups can be connected in series, for example. One of skill in the art will understand that any number of battery cell connection configurations are practicable utilizing the battery cell architectures herein disclosed, and will further recognize that vehicular applications are not limited to the vehicle architecture as described. Battery pack 20 can provide energy to a traction inverter 2 which converts the direct current (DC) battery voltage to a three-phase alternating current (AC) signal which is used by a drive motor 3 to propel the vehicle 1. An engine 5 can be used to drive a generator 4, which in turn can provide energy to recharge the battery pack 20 via the inverter 2. External (e.g., grid) power can also be used to recharge the battery pack 20 via additional circuitry (not shown). Engine 5 can comprise a gasoline or diesel engine, for example.

Battery cell 10 generally operates by reversibly passing lithium ions between Anode 11 and cathode 14. Lithium ions move from cathode 14 to Anode 11 while charging, and move from Anode 11 to cathode 14 while discharging. At the beginning of a discharge, Anode 11 contains a high concentration of intercalated/alloyed lithium ions while cathode 14 is relatively depleted, and establishing a closed external circuit between Anode 11 and cathode 14 under such circumstances causes intercalated/alloyed lithium ions to be extracted from Anode 11. The extracted lithium atoms are split into lithium ions and electrons as they leave an intercalation/alloying host at an electrode-electrolyte interface. The lithium ions are carried through the micropores of separator 18 from Anode 11 to cathode 14 by the ionically conductive electrolyte 17 while, at the same time, the electrons are transmitted through the external circuit from Anode 11 to cathode 14 to balance the overall electrochemical cell. This flow of electrons through the external circuit can be harnessed and fed to a load device until the level of intercalated/alloyed lithium in the negative electrode falls below a workable level or the need for power ceases.

Battery cell 10 may be recharged after a partial or full discharge of its available capacity. To charge or re-power the lithium ion battery cell, an external power source (not shown) is connected to the positive and the negative electrodes to drive the reverse of battery discharge electrochemical reactions. That is, during charging, the external power source extracts the lithium ions present in cathode 14 to produce lithium ions and electrons. The lithium ions are carried back through the separator by the electrolyte solution, and the electrons are driven back through the external circuit, both towards Anode 11. The lithium ions and electrons are ultimately reunited at the negative electrode, thus replenishing it with intercalated/alloyed lithium for future battery cell discharge.

Lithium ion battery cell 10, or a battery module or pack comprising a plurality of battery cells 10 connected in series and/or in parallel, can be utilized to reversibly supply power and energy to an associated load device. Lithium ion batteries may also be used in various consumer electronic devices (e.g., laptop computers, cameras, and cellular/smart phones), military electronics (e.g., radios, mine detectors, and thermal weapons), aircrafts, and satellites, among others. Lithium ion batteries, modules, and packs may be incorporated in a vehicle such as a hybrid electric vehicle (HEV), a battery electric vehicle (BEV), a plug-in HEV, or an extended-range electric vehicle (EREV) to generate enough power and energy to operate one or more systems of the vehicle. For instance, the battery cells, modules, and packs may be used in combination with a gasoline or diesel internal combustion engine to propel the vehicle (such as in hybrid electric vehicles), or may be used alone to propel the vehicle (such as in battery powered vehicles).

Returning to FIG. 1, electrolyte 17 conducts lithium ions between anode 11 and cathode 14, for example during charging or discharging the battery cell 10. The electrolyte 17 comprises one or more solvents, and one or more lithium salts dissolved in the one or more solvents. Suitable solvents can include cyclic carbonates (ethylene carbonate, propylene carbonate, butylene carbonate), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,3-dimethoxypropane, 1,2-dimethoxyethane (DME), 1-2-diethoxyethane, ethoxymethoxyethane), cyclic ethers (tetrahydrofuran, 2-methyltetrahydrofuran, 1,3-dioxolane), and combinations thereof. A non-limiting list of lithium salts that can be dissolved in the organic solvent(s) to form the non-aqueous liquid electrolyte solution include LiClO₄, LiAlCl₄, LiI, LiBr, LiSCN, LiBF₄, LiB(C₆H₅)₄ LiAsF₆, LiCF₃SO₃, LiN(CF₃SO₂)₂, LiN(FSO₂)₂, LiPF₆, and mixtures thereof

The microporous polymer separator 18 can comprise, in one embodiment, a polyolefin. The polyolefin can be a homopolymer (derived from a single monomer constituent) or a heteropolymer (derived from more than one monomer constituent), either linear or branched. If a heteropolymer derived from two monomer constituents is employed, the polyolefin can assume any copolymer chain arrangement including those of a block copolymer or a random copolymer. The same holds true if the polyolefin is a heteropolymer derived from more than two monomer constituents. In one embodiment, the polyolefin can be polyethylene (PE), polypropylene (PP), or a blend of PE and PP. The microporous polymer separator 18 may also comprise other polymers in addition to the polyolefin such as, but not limited to, polyethylene terephthalate (PET), polyvinylidene fluoride (PVdF), and or a polyamide (Nylon). Separator 18 can optionally be ceramic-coated with materials including one or more of ceramic type aluminum oxide (e.g., Al₂O₃), and lithiated zeolite-type oxides, among others. Lithiated zeolite-type oxides can enhance the safety and cycle life performance of lithium ion batteries, such as battery cell 10. Skilled artisans will undoubtedly know and understand the many available polymers and commercial products from which the microporous polymer separator 18 may be fabricated, as well as the many manufacturing methods that may be employed to produce the microporous polymer separator 18.

Active material 16 can include any lithium-based active material that can sufficiently undergo lithium intercalation and deintercalation while functioning as the positive terminal of battery cell 10. Active material 16 can also include a polymer binder material to structurally hold the lithium-based active material together. The active material 16 can comprise lithium transition metal oxides (e.g., layered lithium transitional metal oxides) or chalcogen materials. Cathode current collector 15 can include aluminum or any other appropriate electrically conductive material known to skilled artisans, and can be formed in a foil or grid shape. Cathode current collector 15 can be treated (e.g., coated) with highly electrically conductive materials, including one or more of conductive carbon black, graphite, carbon nanotubes, carbon nanofiber, graphene, and vapor growth carbon fiber (VGCF), among others. The same highly electrically conductive materials can additionally or alternatively be dispersed within the host material 13.

Lithium transition metal oxides suitable for use as active material 16 can comprise one or more of spinel lithium manganese oxide (LiMn₂O₄), lithium cobalt oxide (LiCoO₂), a nickel-manganese oxide spinel (Li(Ni_{0.5}Mn_{1.5})O₂), a layered nickel-manganese-cobalt oxide (having a general formula of xLi₂MnO₃·(1−x)LiMO₂, where M is composed of any ratio of Ni, Mn and/or Co). A specific example of the layered nickel-manganese oxide spinel is xLi₂MnO₃·(1−x)Li(Ni_{1/3}Mn_{1/3}Co_{1/3})O₂. Other suitable lithium-based active materials include Li(Ni_{1/3}Mn_{1/3}Co_{1/3})O₂), LiNiO₂, Li_{x+y}Mn_{2-y}O₄ (LMO, 0<x<1 and 0<y<0.1), or a lithium iron polyanion oxide, such as lithium iron phosphate (LiFePO₄) or lithium iron fluorophosphate (Li₂FePO₄F). Other lithium-based active materials may also be utilized, such as LiNiₓM₁₋ₓO₂ (M is composed of any ratio of Al, Co, and/or Mg), LiNi₁₋ₓCo_{1-y}Mn_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LiₓMn₂₋ₓAl_{y}O₄), lithium vanadium oxide (LiV₂O₅), Li₂MSiO₄ (M is composed of any ratio of Co, Fe, and/or Mn), and any other high efficiency nickel-manganese-cobalt material (HE-NMC, NMC or LiNiMnCoO₂). By “any ratio” it is meant that any element may be present in any amount. So, for example, M could be Al, with or without Co and/or Mg, or any other combination of the listed elements. In another example, anion substitutions may be made in the lattice of any example of the lithium transition metal based active material to stabilize the crystal structure. For example, any O atom may be substituted with an F atom.

Chalcogen-based active material can include one or more sulfur and/or one or more selenium materials, for example. Sulfur materials suitable for use as active material 16 can comprise sulfur carbon composite materials, S₈, Li₂S₈, Li₂S₆, Li₂S₄, Li₂S₂, Li₂S, SnS₂, and combinations thereof. Another example of sulfur-based active material includes a sulfur-carbon composite. Selenium materials suitable for use as active material 16 can comprise elemental selenium, Li₂Se, selenium sulfide alloys, SeS₂, SnSeₓS_{y} (e.g., SnSe_{0.5}S_{0.5}) and combinations thereof. The chalcogen-based active material of the positive electrode 22′ may be intermingled with the polymer binder and the conductive filler. Suitable binders include polyvinylidene fluoride (PVDF), polyethylene oxide (PEO), an ethylene propylene diene monomer (EPDM) rubber, carboxymethyl cellulose (CMC)), styrene-butadiene rubber (SBR), styrene-butadiene rubber carboxymethyl cellulose (SBR-CMC), polyacrylic acid (PAA), cross-linked polyacrylic acid-polyethylenimine, polyimide, or any other suitable binder material known to skilled artisans. Other suitable binders include polyvinyl alcohol (PVA), sodium alginate, or other water-soluble binders. The polymer binder structurally holds the chalcogen-based active material and the conductive filler together. An example of the conductive filler is a high surface area carbon, such as acetylene black or activated carbon. The conductive filler ensures electron conduction between the positive-side current collector 26 and the chalcogen -based active material. In an example, the positive electrode active material and the polymer binder may be encapsulated with carbon. In an example, the weight ratio of S and/or Se to C in the positive electrode 22′ ranges from 1:9 to 9:1.

The anode current collector 12 can include copper, aluminum, stainless steel, or any other appropriate electrically conductive material known to skilled artisans. Anode current collector 12 can be treated (e.g., coated) with highly electrically conductive materials, including one or more of conductive carbon black, graphite, carbon nanotubes, carbon nanofiber, graphene, and vapor growth carbon fiber (VGCF), among others. The host material 13 applied to the anode current collector 12 can include any lithium host material that can sufficiently undergo lithium ion intercalation, deintercalation, and alloying, while functioning as the negative terminal of the lithium ion battery 10. Host material 13 can optionally further include a polymer binder material to structurally hold the lithium host material together. For example, in one embodiment, host material 13 can further include a carbonaceous material (e.g., graphite) and/or one or more of binders (e.g., polyvinyldiene fluoride (PVdF), an ethylene propylene diene monomer (EPDM) rubber, carboxymethoxyl cellulose (CMC), and styrene, 1,3-butadiene polymer (SBR)).

Silicon has the highest known theoretical charge capacity for lithium, making it one of the most promising anode host materials 13 for rechargeable lithium-ion batteries. In two general embodiments, a silicon host material 13 can comprise Si particles, or SiOₓ particles. SiOₓ particles, wherein generally x≤2, can vary in composition. In some embodiments, for some SiOₓ particles, x≈1. For example, x can be about 0.9 to about 1.1, or about 0.99 to about 1.01. Within a body of SiOₓ particles, SiO₂ and/or Si domains may further exist. Silicon host material 13 comprising Si particles or SiOₓ particles can comprise average particle diameters of about 20 nm to about 20 μm, among other possible sizes.

During the first cycling of a “fresh” anode, silicon-based anodes typically exhibit inferior initial coulombic efficiency due to the generally irreversible capture of lithium during the first cycle. For example, in a silicon electrode, a solid electrolyte interface (SEI) layer can form on the host material 13 and capture lithium. In another example, in a SiOₓ electrode, lithium can become irreversibly captured through the formation of Li₄SiO₄ and/or Li₂O within the host material 13. In either instance, the poor initial coulombic efficiency resulting from the inability of lithium to transport back to the cathode 14 can require excessive lithium loading of cathode active material 16 to compensate for the lithium consumed by the anode 11 during the first cycle, which detrimentally reduces the energy density of the battery cell 10.

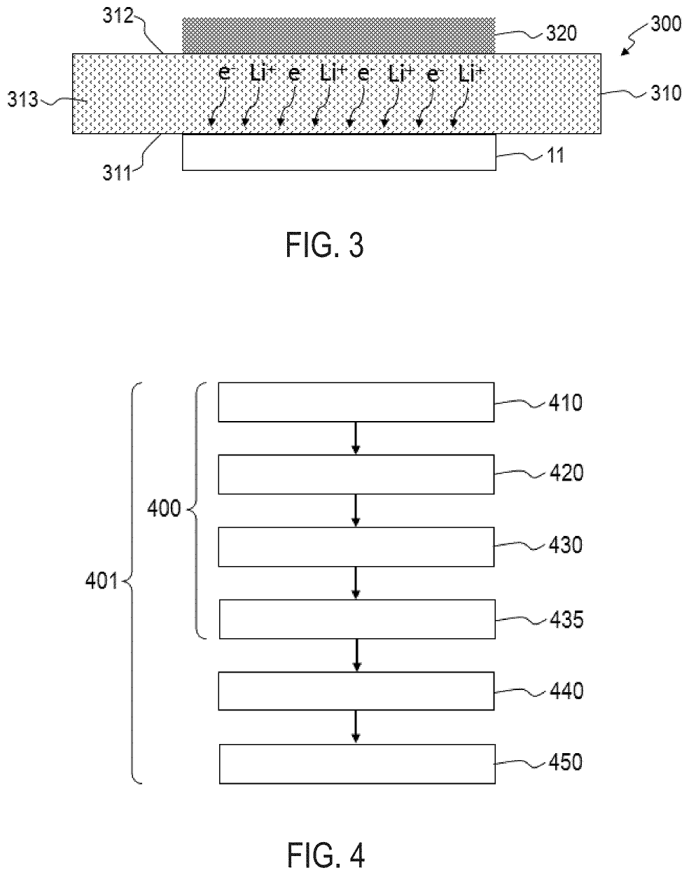

Accordingly, provided herein are methods for pre-lithiating battery anodes, and appurtenant methods for manufacturing battery cells. The methods provide anodes and battery cells which exhibit high initial coulombic efficiency and generally increase the performance of battery cells. The methods will be described in relation to the battery cell 10 of FIG. 1 and a pre-lithiating system 300 illustrated FIG. 3 for the purpose of clarity only, and one of skill in the art will understand that such methods are not intended to be limited thereby. FIG. 3 illustrates a pre-lithiating system 300 comprising an anode 11, a pre-lithiating separator 310, and a lithium source 320. FIG. 4 illustrates a block diagram of a method 400 for pre-lithiating an anode 11, comprising providing 410 an anode 11, disposing 420 a first side 311 of an electrically conductive pre-lithiating separator 310 contiguous with the anode 11, and disposing 430 a lithium source 320 contiguous with a second side 312 of the pre-lithiating separator 310 for a period of time such that lithium ions migrate to the anode 11 host material 13 via the pre-lithiating separator 310. In practice, the pre-lithiating separator 310 prelithiates the anode 11 by creating a controlled electrical short between the anode 11 and the lithium source 320 such that lithium migrates to the anode 11 host material 13.

The lithium source 320 can comprise pure (e.g., >95% pure) elemental lithium, or a lithium alloy, among other bulk sources of lithium. The lithium source 320 can take the form of a plate, thin foil, or other configuration suitable for the application of method 400 and/or method 401 described below. For example, in a manufacturing setting, the lithium source 320 can be a lithium plate, or lithium roller, so as to provide a sustained source of lithium over many manufacturing cycles.

As described above, the anode 11 comprises silicon or SiOₓ host material 13, and accordingly comprises Si particles, or SiOₓ particles, wherein x≤2. The pre-lithiating separator 310 comprises a porous body 313 generally saturated with electrolyte 17 (i.e., one or more solvents, such as those described above, and one or more lithium salts, such as those described above) so as to facilitate the movement of lithium ions and lithium salts therethrough. In other words, the body 313 is ionically conductive by virtue of its pores. The body 313 can comprise a polymeric material, such as those described above used to form conventional battery separators 18. Additionally or alternatively, the body 313 can comprise one or more other polymers, such as polyimide, polyetherimide, polysulfone, polyethersulfone, acrylics, polycarbonate and polyamide. Furthermore, the body 313 is electrically conductive such that electrons can travel from the lithium source 320 to the anode 11. Accordingly, the pre-lithiating separator 310 can further comprise conductive fillers, for example as imbedded in a polymer matrix. Conductive fillers can comprise electrically conductive carbon material, such as conductive carbon black, graphite, carbon nanotubes, carbon nanofiber, graphene, and VGCF, and/or other electrically conductive materials such as one or more of nickel fibers and/or particles and steel fibers and/or particles, and combinations thereof

The porosity and the resistance of the pre-lithiating separator 310 can be tuned to achieve a particular anode 11 lithium loading rate. If the resistance of the pre-lithiating separator 310 is too low, and/or if the porosity of the pre-lithiating separator 310 is too high, lithium may load into the anode 11 too quickly and damage the host material 13 (e.g., by lithium plating and/or electrode/particle cracking). Alternatively, if the resistance of the pre-lithiating separator 310 is too high, and/or if the porosity of the pre-lithiating separator 310 is too low, lithium may load into the anode 11 too slowly, such that the technique may not be economically feasible for scalable manufacturing processes. The ionic conductivity of the pre-lithiating separator 310, which is largely controlled by the porosity and tortuosity thereof, can be tuned by increasing the number and/or size of voids within the body 313, wherein a larger number and/or size of voids increases the ionic conductivity and a lower number and/or size of voids decreases the ionic conductivity. Similarly, the resistance of the pre-lithiating separator 310 can be tuned by varying the amount of conductive fillers in the porous body 313, wherein a higher conductive filler loading decreases the resistance and a lower conductive filler loading increases the resistance. In some embodiments, the body 313 can have a porosity of about 20% to about 80%, or about 30% to about 60%. In one embodiment, the resistance of the pre-lithiating separator 310 can be greater than about 10 ohms, greater than about 50 ohms, or about 10 ohms to about 2,000 ohms. In some embodiments, the resistance of the pre-lithiating separator 310 is about 250 ohms to about 350 ohms, or about 300 ohms.

Method 400 can further comprise controlling 435 the current and/or voltage between the anode 11 and the lithium source 320. In one embodiment, controlling 435 the current and/or voltage between the anode 11 and the lithium source 320 comprises applying a voltage to the anode 11 and the lithium source 320 such that the magnitude of the electrical potential between the anode 11 and the lithium source 320 increases. In such an embodiment, the rate of lithium transfer from the lithium source 320 to the anode 11 can be increased. In one embodiment, controlling 435 the current and/or voltage between the anode 11 and the lithium source 320 comprises maintaining a constant current between the anode 11 and the lithium source 320 while lithium ions migrate to the host material 13. The current can be maintained via a potentiostat, for example. In such an embodiment, under constant current the rate of lithium transfer to the anode 11 can be quantified as a function of time. Therefore, the period of time during which the lithium ions migrate to the host material 13 via the pre-lithiating separator 310 can be monitored and controlled to achieve a desire pre-lithiation of the anode 11. Similarly, the current can simply be monitored (i.e., and allowed to fluctuate), and the period of time during which the lithium ions migrate to the host material 13 via the pre-lithiating separator 310 can be monitored and controlled to achieve a desire pre-lithiation of the anode 11.

An anode 11 can be pre-lithiated to varying degrees, as desired. In general, an anode can be pre-lithiated via method 400 to load the anode 11 with approximately the amount, or up to the amount, of lithium that would otherwise be irreversibly captured during the first cycle of a battery, as described above. The magnitude of pre-lithiation can be defined as a percentage of lithium capacity for a given anode host material 13. For example, if the host material 13 comprises nano-particle silicon, the anode 11 can be pre-lithiated from about 30% to about 40% of the lithium capacity of the anode 11. In another example, if the host material 13 comprises micro-particle silicon, the anode 11 can be pre-lithiated from about 10% to about 20% of the lithium capacity of the anode 11. In another example, if the host material 13 comprises SiOₓ, the anode 11 can be pre-lithiated from about 20% to about 40% of the lithium capacity of the anode 11.

Returning to FIG. 4, a method 401 for manufacturing a battery cell is also provided. Method 401 comprises implementing method 400, and further separating 440 the pre-lithiating separator 310 from the lithiated anode 11; and combining 450 the lithiated anode 11 with a battery separator 18 and a lithium cathode 14 to form a battery cell 10. In some embodiments, disposing 420 a first side 311 of an electrically conductive pre-lithiating separator 310 contiguous with the anode 11 occurs during a roll-to-roll battery cell fabrication process. Roll-to-roll battery cell fabrication processes are known in the art.

### EXAMPLE 1

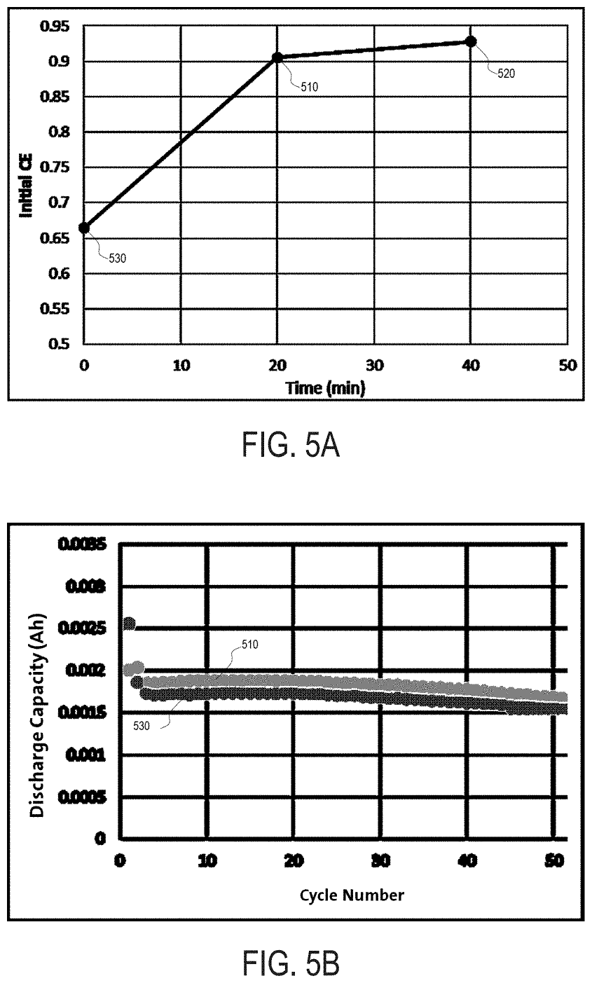

Two aramid pre-lithiating separators impregnated with 10 wt. % carbon nanofibers and having 302 ohm electric conductivity were used to pre-lithiate two identical silicon host material anodes 510, 520 for 10 minutes and 20 minutes, respectively. A third identical silicon host material anode 530 was provided but not pre-lithiated. FIG. 5A is a graph illustrating the initial coulombic efficiency of each anode. It can be seen that the initial coulombic efficiency of the two pre-lithiated anodes 510, 520 are each much higher than the non-lithiated anode 530. FIG. 5B is a graph illustrating the discharge capacity of pre-lithiated anode 510 and the non-lithiated anode 530 over charge/discharge 50 cycles. Focusing particularly on the first two cycles, the pre-lithiated anode 510 exhibits a significantly lower discharge capacity drop between the first, second, and third charge/discharge cycles relative to the non-lithiated anode 530.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for pre-lithiating an anode, the method comprising:
providing the anode having a host material comprising silicon particles or SiOₓ particles, wherein x is less than or equal to 2;
disposing a first side of an electrically conductive pre-lithiating separator contiguous with the anode, wherein the pre-lithiating separator comprises a porous body, one or more solvents, and one or more lithium ions; and
disposing a lithium source contiguous with a second side of the pre-lithiating separator for a period of time such that lithium ions migrate to the host material via the pre-lithiating separator.

2. The method of claim 1, further comprising applying a voltage to the anode and the lithium source such that the magnitude of the potential between the anode and the lithium source increases.

3. The method of claim 1, further comprising maintaining a constant current between the lithium source and the anode while lithium ions migrate to the host material.

4. The method of claim 1, wherein the lithium source comprises elemental lithium or a lithium alloy.

5. The method of claim 1, wherein the host material comprises an average particle diameter of about 20 nanometers to about 20 micrometers.

6. The method of claim 1, wherein the host material comprises SiOₓ particles, and the host material further comprises Si and/or Si₂ domains within the SiOₓ particles.

7. The method of claim 1, wherein the pre-lithiating separator comprises an electric resistance of about 10 ohms to about 2,000 ohms.

8. The method of claim 1, wherein the pre-lithiating separator comprises a porosity of about 20% to about 80%.

9. The method of claim 1, wherein the pre-lithiating separator body comprises a polymeric material.

10. The method of claim 1, wherein the pre-lithiating separator body comprises an electrically conductive filler.

11. The method of claim 10, wherein the electrically conductive filler comprises one or more electrically conductive carbon materials, nickel fibers and/or particles and steel fibers and/or particles, and combinations thereof.

12. Method for manufacturing a battery cell, the method comprising:
providing an anode having a host material comprising silicon particles or SiOₓ particles, wherein x is less than or equal to 2;
disposing a first side of an electrically conductive pre-lithiating separator contiguous with the anode, wherein the pre-lithiating separator comprises a porous body, one or more solvents, and one or more lithium ions;
disposing a lithium source contiguous with a second side of the pre-lithiating separator for a period of time such that lithium ions migrate to the host material via the pre-lithiating separator to form a lithiated anode;
separating the pre-lithiating separator from the lithiated anode; and
combining the lithiated anode with a battery separator and a lithium cathode to form the battery cell.

13. The method of claim 12, wherein disposing the first side of the electrically conductive pre-lithiating separator contiguous with the anode occurs during a roll-to-roll battery cell fabrication process.

14. The method of claim 12, further comprising applying a voltage to the anode and the lithium source such that the magnitude of the potential between the anode and the lithium source increases.

15. The method of claim 12, further comprising maintaining a constant current between the lithium source and the anode while lithium ions migrate to the host material.

16. The method of claim 12, wherein the lithium source comprises elemental lithium or a lithium alloy.

17. The method of claim 12, wherein the host material comprises an average particle diameter of about 20 nanometers to about 20 micrometers.

18. The method of claim 12, wherein the host material comprises SiOₓ particles, and the host material further comprises Si and/or Si₂ domains within the SiOₓ particles.

19. The method of claim 12, wherein the pre-lithiating separator body comprises a polymeric material.

20. The method of claim 12, wherein the pre-lithiating separator body comprises an electrically conductive filler.
